(19) United States
(12) Patent Application Publication
(10) Pub. No.: US 2015/0220075 A1
(43) Pub. Date: Aug. 6, 2015

(54) SYSTEM AND METHOD FOR REMOTE CONTROL OF HOME APPLIANCES WITHOUT INFRASTRUCTURE CHANGES

(71) Applicant: SWITCHBEE LTD., Natanya (IL)

(72) Inventor: Amichai Ziv, Natanya (IL)

(73) Assignee: SWITCHBEE LTD., Natanya (IL)

(21) Appl. No.: 14/421,172

(22) PCT Filed: Aug. 14, 2013
(86) PCT No.: PCT/IL2013/050689

§ 371 Date: Feb. 12, 2015

Related U.S. Application Data
(60) Provisional application No. 61/682,779, filed on Aug. 14, 2012.

(51) Int. Cl. G05B 19/04; G08C 23/04; G08C 17/02; G08C 23/02

(52) U.S. Cl. CPC G05B 19/041; G08C 23/02; G08C 23/04; G08C 17/02; G08C 2201/93; G08C 2201/30

(57) ABSTRACT

The present invention relates to a system and method for controlling a plurality of appliances, which may be part of a smart home or environment. The method and system according to embodiments of the invention enable using a single easily programmable controller to control a plurality of appliances, each appliance using its own pre-existing control application, with no changes of infrastructure required. Additionally, a single controller, according to embodiments of the invention may enable remote control of appliances over a wide area.

### RELATED APPLICATION

The present invention gains priority from U.S. Provisional Patent Application No. 61/682,779 filed on Aug. 14, 2012.

### FIELD OF THE INVENTION

The present invention relates to the field of remote controlling of electric appliances.

### BACKGROUND OF THE INVENTION

Home automation has become practical since the early 20th century following the widespread introduction of electricity into the home, and the advancement of information technology. Today, the term “smart home” is used to describe a home or environment which employs a system to control audio and video equipment, lighting, heating, ventilation and air conditioning and motorized curtains systems and other electrical appliances around the house. A variety of interfaces may be used to allow control of the smart home systems.

For example, US 2011/0230236 describes an integrated system for remote monitoring of home appliances by using a cell phone. The cell phone sends an instruction message to a computer having a digital control disk connected to it by an R232 or USB connector. The digital control disk generates a control signal in accordance with the instruction message. The control signal is then sent to a home appliance to turn the appliance on or off.

Communication of remote controllers with their designated appliances is typically done through wireless communication, usually through IR being transmitted from the remote controller to a receiver on the appliance. US 2012/0082461 describes an intermediary device for accepting radio-frequency (RF) signals from a remote control and in turn, generating and broadcasting a plurality of high-power IR signals which may be received by a controlled device after one or more reflections from objects and/or room surfaces. US 2012/0082461 explains that reliable control of devices is thus obtained even in situations where merely transmitting a typical IR signal may not provide reliable control of the device.

None of these publications and indeed none of the products available today, offer a readily affordable, simple solution for household users to control a plurality of appliances in their house without having to purchase and install additional hardware and/or replace existing home appliances.

Thus, despite interest in home automation, such systems are not widespread; they are still considered a gimmick or the domain of the rich.

### SUMMARY OF THE INVENTION

Embodiments of the present invention provide a system and method for controlling a plurality of appliances, which may be part of a smart home or environment.

The method and system according to embodiments of the invention enable using a single easily programmable controller to control a plurality of appliances, each appliance using its own pre-existing control application, with no changes of infrastructure required. Additionally, a single controller, according to embodiments of the invention may enable remote control of appliances over a wide area.

According to one embodiment there is provided a system for remote control of appliances, which includes a central unit to accept a command and to generate a control signal based on the command; and a transceiver in wireless communication with the central unit and in wireless communication with an electrical appliance to receive the control signal from the central unit and to transmit to the electrical appliance an operating signal according to the control signal.

According to some embodiments the system need not include a central unit. The transceiver may receive input from a user directly.

A transceiver according to embodiments of the invention includes a receiver to receive a command and an array of transmitters, each transmitter configured to be individually controlled, to transmit an operating signal to an appliance.

Also provided is a method for remote control of appliances. The method includes the steps of receiving a command from a control unit; generating a control signal based on the received command; and transmitting the control signal to a remote wireless transceiver, the control signal to generate in the transceiver an operational signal to control an electrical appliance.

These features enable simple control of a variety of appliances over varying areas with no need for adding specialized hardware.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a system for remote control of appliances, according to one embodiment of the invention;

FIG. 2 schematically illustrates a system having a controller unit, according to an embodiment of the invention;

FIG. 3 schematically illustrates a controller unit according to one embodiment of the invention;

FIGS. 4A and 4B schematically illustrate a transceiver operable according to embodiments of the invention;

FIG. 5 schematically illustrates a system including a learning controller unit, according to embodiments of the invention;

FIG. 6 schematically illustrates a method for remote control of appliances according to embodiments of the invention; and

FIG. 7 schematically illustrates a smart house operable according to an embodiment of the invention.

### DETAILED DESCRIPTION OF THE INVENTION

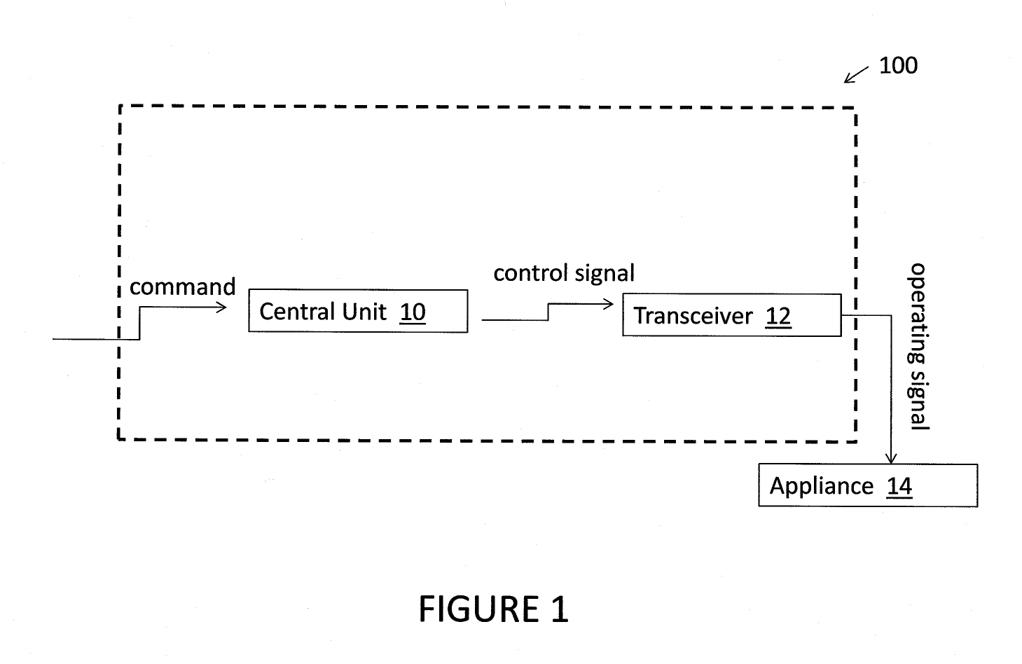

Reference is now made to FIG. 1 which schematically illustrates a system for remote control of end devices, such as household appliances, according to one embodiment of the invention. According to one embodiment the system 100 includes a central unit 10 which can accept a control command, wirelessly or through a wired or other suitable connection. The central unit 10 then generates a control signal based on the command and sends the control signal to a transceiver 12 which is in wireless communication with the central unit 10. The transceiver 12 is also in wireless communication with an end device such as electrical appliance 14 such that the transceiver 12 may receive a control signal from the central control unit and transmit to the electrical appliance an operating signal according to the control signal. Transceiver 12 may include one or more transmitters.

According to some embodiments one or more home or other appliances can be controlled using a single central unit. Home appliances include, for example, light fixtures, air conditioners, ovens, heaters, electrical curtains, and video and audio systems. Other appliances may also be used.

The central unit 10 may include a memory such as a RAM or flash memory and a processor to generate different control signals (e.g., signals having specific strengths, direction or frequency. The signals may have other varying features) intended for different transceivers or for different transmitters within the transceiver. The central unit 10 may also send delayed or timed control signals according to a pre-planned schedule. Additionally, a control signal may be generated based on more than one command.

A generated control signal is sent wirelessly to transceiver 12. The control signal can be WiFi, Bluetooth, ZigBee, or other protocol or Proprietary RF communication or even a wired signal.

According to one embodiment the transceiver 12 may be physically attached to or connected to an appliance 14, for example, transceiver 12 may be a module that can be plugged into or otherwise attached to appliance 14. Each transceiver 12 may be identified through unique URI (uniform resource identifier), URN (uniform resource name) and/or other electronic addresses. Additionally, each transmitter in the transceiver 12 may have its own electronic address.

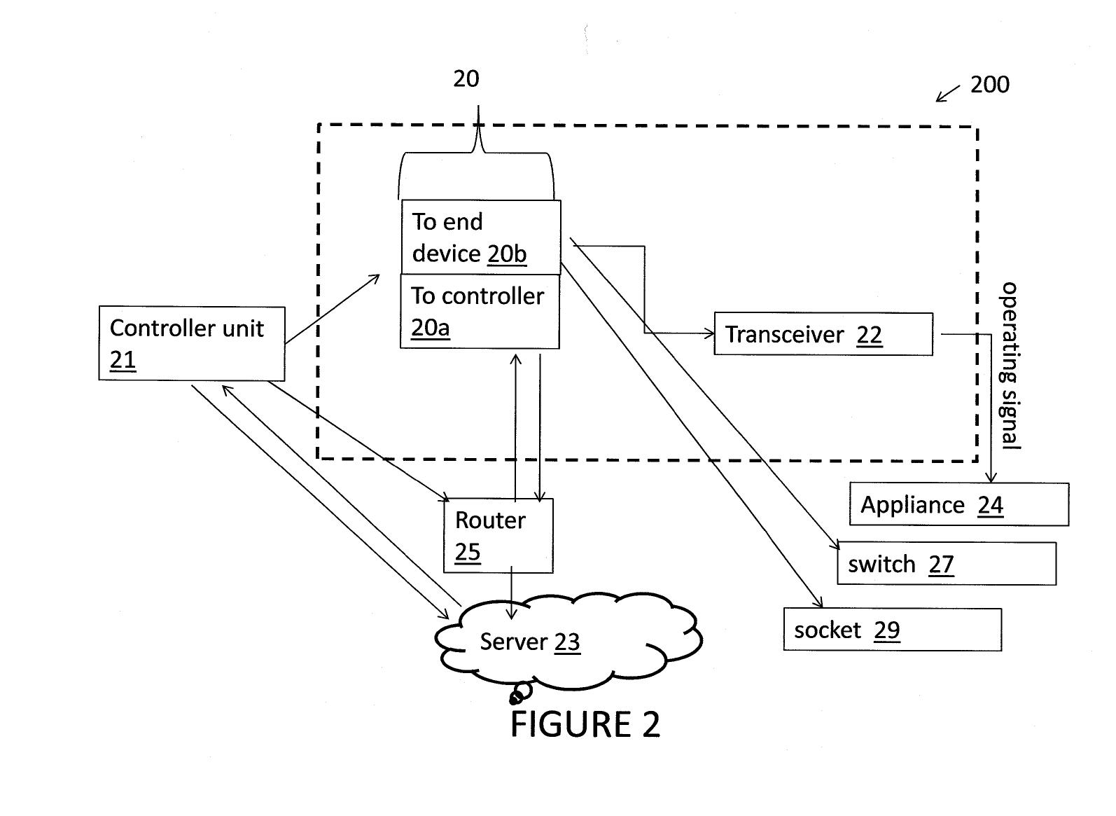

In some embodiments the system may include a controller unit, for example, as schematically illustrated in FIG. 2. The system 200 includes a controller unit 21 which sends a command, such as, by using Internet communications protocols (e.g., Transmission Control Protocol (TCP) and Internet Protocol (IP), to the central unit 20. The controller unit 21 accepts input from a user and sends the input from the user to the central unit 20 as a remote control command signal. The central unit 20 then sends a control signal to a transceiver 22 which may then send an operating signal to an appliance 24 to control the appliance.

According to one embodiment the system need not include a central unit 20 and a remote control command signal may be sent from the controller unit 21 directly to the transceiver 22.

The controller unit 21 may be or may include a sensor such as an image sensor, an audio sensor (e.g., a voice or speech detector), motion or presence detector (e.g, a PIR (passive IR) sensor for detecting quick temperature changes occurring when, for example, a human or animal appears in a room) or any other unit capable of accepting input from a user such as a cellular phone, tablet or other form of user input device. The controller 21 may be a mobile device (e.g. Smartphone tablet etc) or may be located at a fixed location. The controller unit 21 typically includes a communication module to transmit or send the remote control command. The communication module may be a WiFi, RF transmitter, an IR transmitter or any other suitable wireless device. Alternatively, the controller unit 21 may be connected through a wired connection to the central unit 20 (e.g., through an appropriate USB, Lan or other connection) and the remote control command may be sent over the wired connection. According to some embodiments the controller unit 21 may be a peripheral device on the central unit 20, such as a camera or microphone.

According to one embodiment the controller unit 21 is configured to communicate with a server 23 and/or with a router 25 (which may be in communication with the server 23 and/or the central unit 20), for example, the user may download from the server 23 a remote control application, and use this application to transmit to the central unit 20 commands (e.g., a TCP/IP communication) associated with the remote control application. The central unit 20 may also be configured to communicate with the server 23 (possibly through router 25). The central unit 20 and/or the transceiver 22 may also communicate with the server 23 either directly or through components of the system 200. For example, the controller unit 21 and/or central unit 20 and/or the transceiver unit 22 may accept software updates from the server 23. The server 23 can also be used as a backup for the system programming status.

The controller unit 21 may connect to the server 23 (and/or to other components in the system 200) via a cellular network. The controller unit 21 may be a mobile device, such as a smartphone, tablet, PC etc, supporting operating systems such as Android, Windows, iOS, Symbian an others.

According to some embodiments the central unit 20 serves as a bridge in a possibly multi-component system in which a single controller may communicate with a plurality of transceivers, end devices and other systems. In its role as a bridge, the central unit 20 may be a two part unit; a first part 20a to communicate with the controller unit 21, typically over Internet communication protocols or 3G telecommunication, and a second part 20b configured to communicate with multiple transceivers 22 or with multiple end devices, such as appliances 24 or with other end devices such as an electronic switch 27 and/or socket 29, typically using IR or other wireless technology such as Bluetooth or ZigBee.

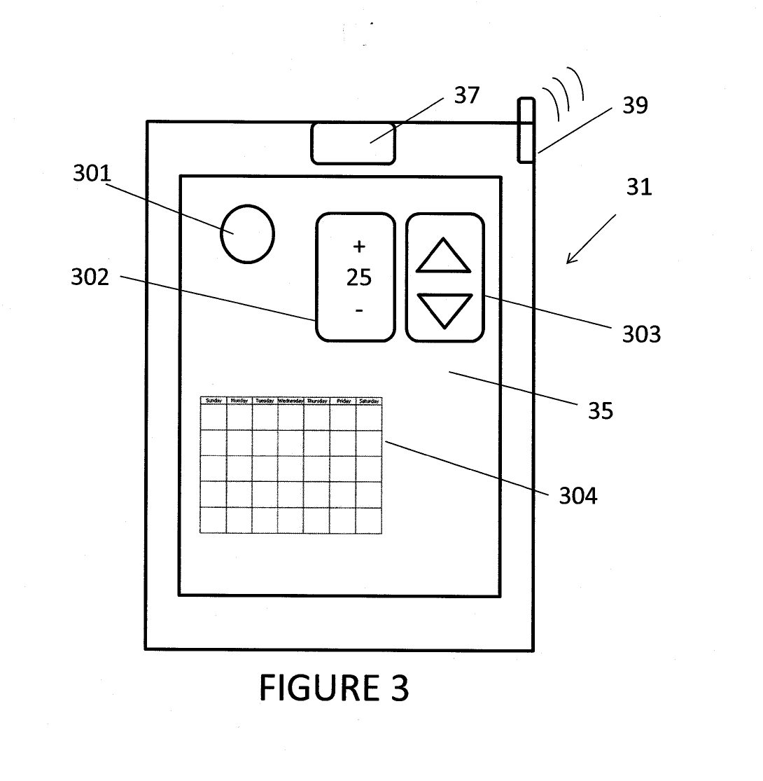

FIG. 3 schematically illustrates a controller unit according to one embodiment of the invention. The controller unit 31 may be a mobile device, such as a smartphone or other wirelessly connected device. According to one embodiment the controller unit 31 supports a GUI (graphical user interface) 35 for controlling appliances (such as appliances 14 and 24). The GUI 35 may be a touch screen such that a user may interact with the controller unit 31 by touching the GUI 35, sliding, tapping or other touch modes. According to other embodiments a user may interact with the controller unit 31 through hand gesturing or posing or through pressing physical buttons, keys or switches.

The controller unit 31 may include universal control functions such as ON/OFF (301), temperature setting (302), amplitude setting (303), timing (hours/dates) of operation (304), TV or radio channel setting, appliance mode or any combination of universally used functions. The GUI 35 may include buttons or keys for the universal functions and/or buttons and keys for specific remote control applications. For example, the GUI 35 may include a dropdown list of remote control applications for the appliances in a specific user's house and the user may choose a remote application to upload onto the GUI by selecting from the list.

The controller unit 31 may be in communication with a remote site (such as a server) to download from that site any specific remote control application, e.g., a remote control for a Sony™ TV or a remote control for an LG™ air-conditioner, etc., so that the control unit 31 may emulate the actual remote control device usually supplied by these manufacturers for controlling appliances already present at the user's house. The controller unit 31 may also send a remote control application to the remote site so that the application may be saved at the remote site for back-up and optionally for sharing with additional users that have access to the remote site.

The controller unit 31 may include a sensor 37, for example, an image sensor or audio sensor, to accept input from a user. The controller unit 31 may include a processor and/or software to identify a user's hands gestures or postures or, for example, to identify an audio signal and to translate the input to a command which may be transmitted through a communication module 39. The communication module 39 may be wireless, suitable for Internet or cellular communication or another appropriate transmitter. Alternatively the communication module 39 may transmit a command through a wired connection.

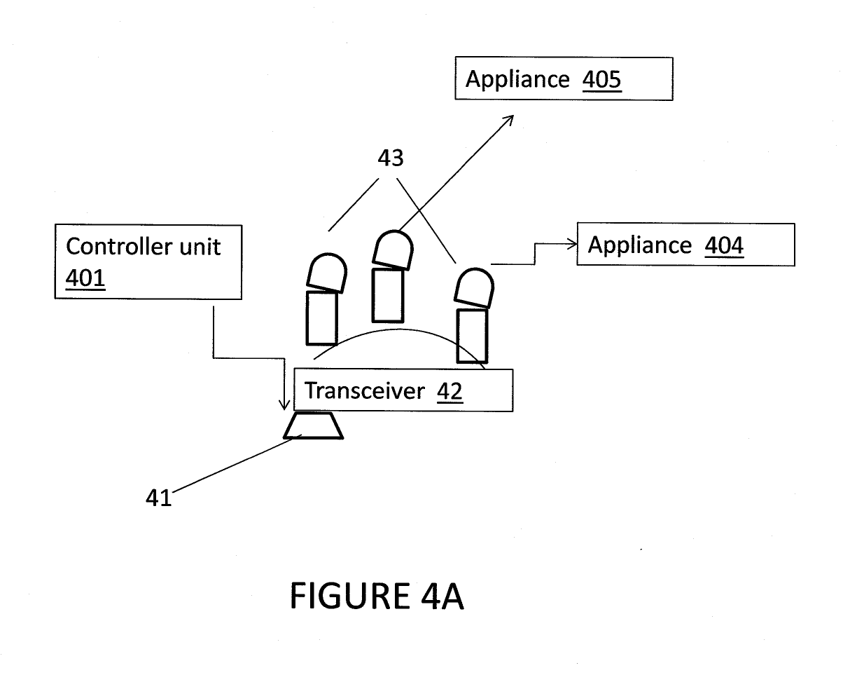

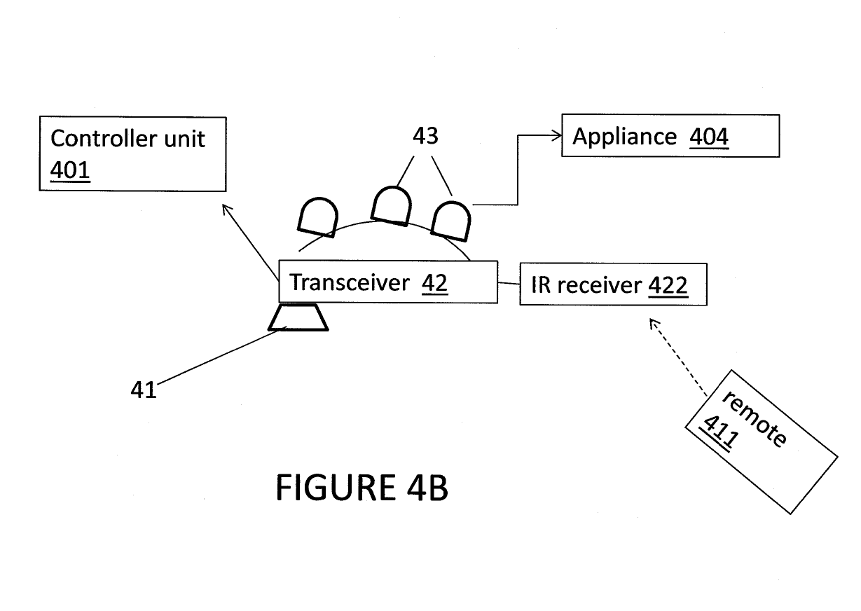

FIGS. 4A and 4B schematically illustrate a transceiver operable according to embodiments of the invention.

According to one embodiment the transceiver 42 includes one or more receivers 41 and one or more transmitter 43, in this example, transmitter including an IR LED or an array of IR LEDs. Other transmitters may be used such as RF transmitters, transmitters of Bluetooth, ultrasound transducers and/or other typically wireless transmitter or any combination of transmitters. The transmitters 43 or the IR LEDs may be arranged to transmit in a specific desired direction and/or in a wide angle so as to cover, for example, an entire room or area in the house.

According to one embodiment the transmitters or IR LEDS may be rotatable or moveable such that each transmitter may be directed at a desired angle or direction.

The transceiver 42 accepts input from a controller unit 401, typically through a central unit, and transmits an operating signal to an appliance 404 and/or 405. According to one embodiment the transceiver 42 accepts input through a wireless receiver (e.g., receiver 41). Input may be directed to an individual or group of transmitters 43 such that only the specified transmitters may transmit an operating signal to the appliance 404 and/or 405.

Appliances 404 and 405 may be different types or the same type of appliance, for example, both may be air conditioners, manufactured by the same or different manufacturer being of the same or different models.

According to one embodiment each transceiver 42 has a unique electronic address such that communication from the controller unit 401 (and/or from a central unit) may be transceiver specific (for example, in a multi-transceiver environment). Additionally, each transmitter 43 or group of transmitters may have their own individual unique switch/control and their own, unique, electronic address such that input from the controller unit 401 (and/or from a central unit) may be directed to a specific transmitter or group of transmitters (from a specific transceiver), such that each transmitter may be individually controlled. This arrangement enables controlling a plurality of appliances, each possibly having their own existing control application, over a wide area (e.g., in different rooms of a house or different floors in a house or building), through a single controller unit or through a single central unit.

According to one embodiment, which is schematically illustrated in FIG. 4B, “on-line” programming of the controller unit 401 is enabled by using transceiver 42. The transceiver 42 may include an IR or other receiver 422 to accept a command from a remote control 411 (namely the remote control purchased with the appliance) for a specific appliance 404. The remote control 411 typically generates a specific sequence of IR (or other) signals at a specific frequency. These signals are captured by receiver 422 and the frequency of the signal or sequence of signals and other characteristics, may then be recorded and saved in transceiver 42 or in a central unit (not shown) that is in communication with the transceiver 42 and may be thus available to controller unit 401. This way previously unknown, external controller applications may be learned by the controller 401 for future use.

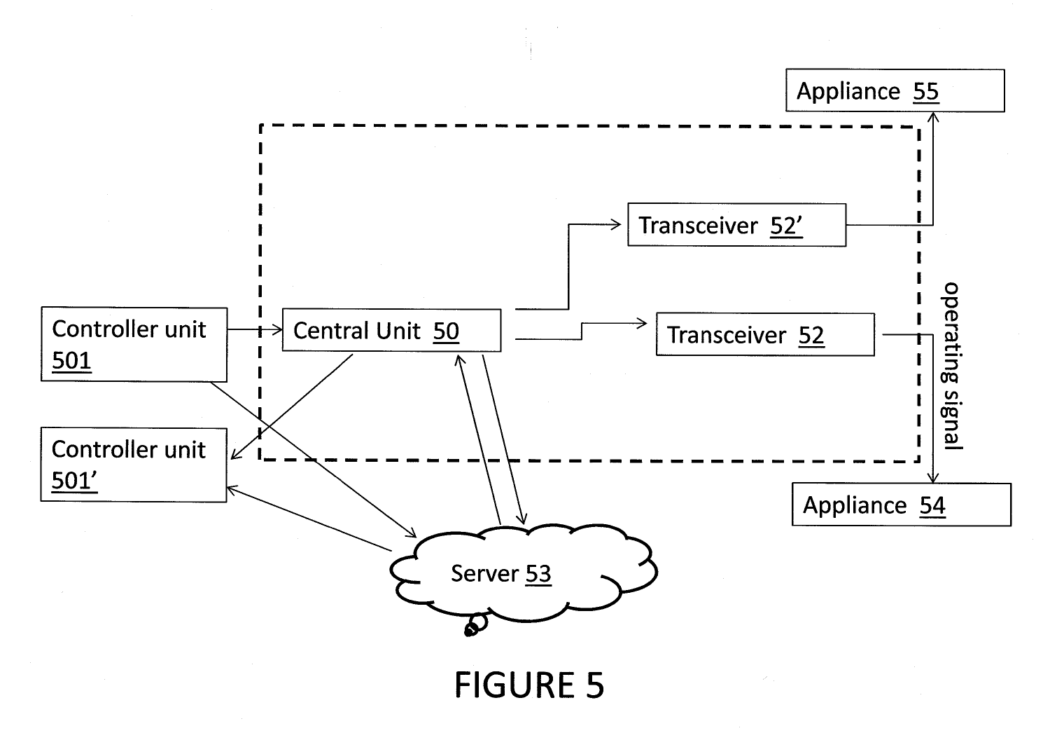

It should be noted that such learning may also occur through a central unit and/or through a remote site, such as a server, for example as exemplified in FIG. 5.

A system 500 includes a first controller unit 501, typically operated by a first user, which is in communication with a central unit 50 and/or in communication with a remote site, such as server 53. According to one embodiment commands sent from controller unit 501 are accepted by central unit 50. These commands are typically processed and then sent to a transceiver 52. The transceiver 52 generates an operating signal based on the commands and sends the operating signal to an appliance 54 for controlling the appliance. Alternatively, the controller unit 501 may communicate directly with transceiver 52.

The first user may download to his controller unit 501, which may be, for example, a smartphone, remote control applications from the Internet or he may program his controller unit 501, using, for example, an appropriate smartphone application. All applications and programs from the controller unit 501 may be saved on the central unit 50 or on the server 53, typically for backup.

A new, second user, having a second controller unit 501′ may have access to the server 53 or to the central unit 50 from which he may download onto his controller unit 501′ the applications stored there. Thus, the first and second users may share applications and new applications and programs may be learned by controller unit 501′. Controller unit 501′ may then communicate through the central unit 50 with a second transceiver 52′ to control a second appliance 55.

A method according to embodiments of the invention may be practiced, for example, in the systems described above.

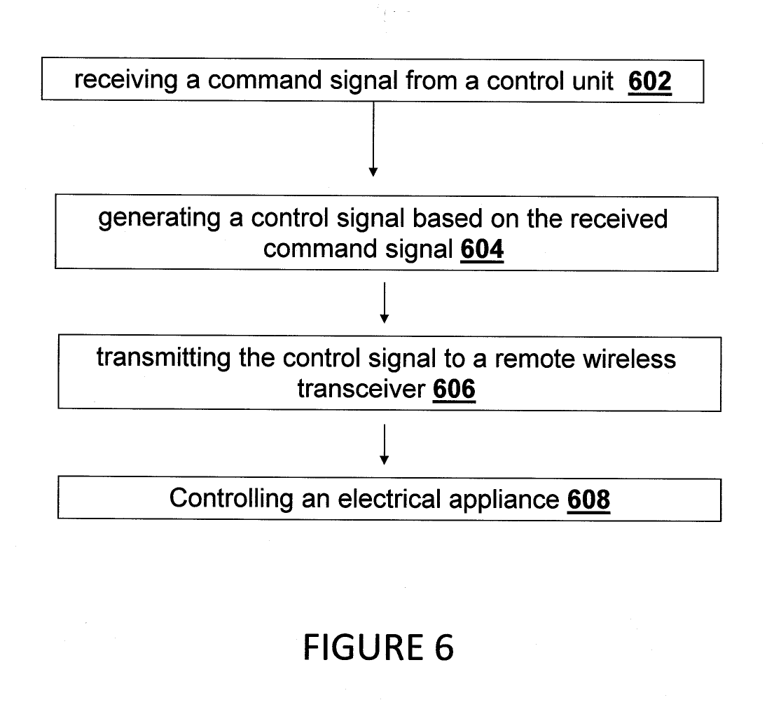

A method for remote control of appliances according to one embodiment of the invention is schematically described in FIG. 6.

The method, according to one embodiment, includes receiving a command from a control unit (602); generating a control signal based on the received command (604) and transmitting the control signal to a remote wireless transceiver (606), the control signal to produce in the transceiver an operational signal, and controlling an electrical appliance based on the operation signal (608).

The operational signal may be a Proprietary RF, WiFi, IR, Bluetooth, ZigBee, ultrasound or other signal typically of a specific frequency or magnitude applicable to existing appliances.

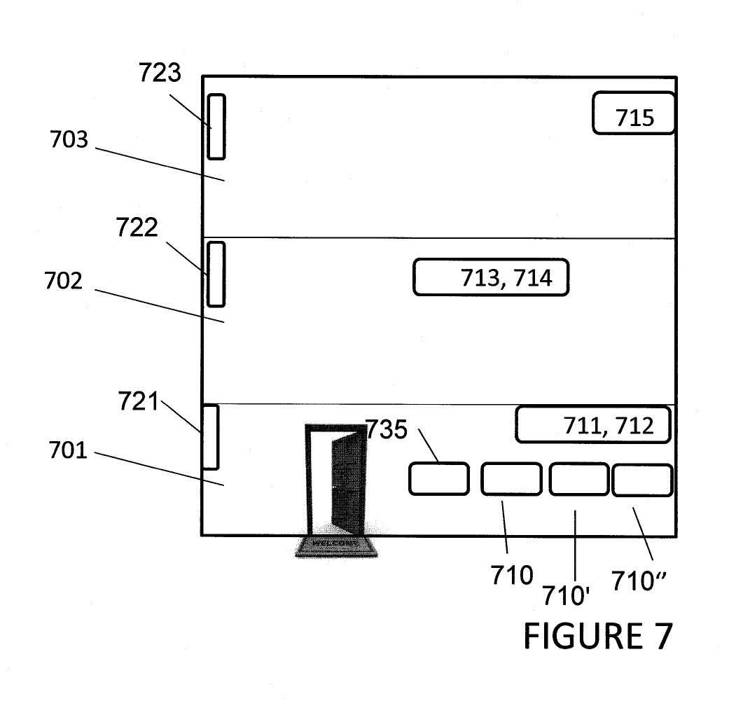

The method may be practiced in a “smart home”, for example, as schematically illustrated in FIG. 7. The house 700, which may be a private residence, a hotel, a building of offices etc., includes 3 floors 701, 702 and 703. Each floor has a transceiver 721, 722, and 723 correspondingly located such that it has wireless access to all the appliances in each floor (e.g., oven and air-conditioner 711 and 712 on the first floor 701, air-conditioner 713 and home entertainment system 714 on the second floor 702 and the light fixtures 715 on the third floor 703).

A resident of the house may control all or some of the appliances through his cell phone or other mobile device or through interacting with a panel 735 which may be separate or an integral part of a central unit 710. The user may press keys or otherwise interact with the panel 735 (for example, the panel 735 may include a motion sensor or human presence sensor and the user may interact with the panel 735 by entering the house). For example, the user may press a single button on panel 735 to activate all or some of the appliances.

According to some embodiments more than one central unit may be used. Each central unit 710, 710′ and 710″ may have a unique address such that the command sent to each central unique may be a central unit specific signal. For example, the user's interaction with the panel 735 (or with another controller) may result in a command being sent to one or more than one of the central units 710, 710′ or 710″. One or more of the central units may generate signals to all or some of the transceivers 721, 722 and 723. An operating signal or signals generated in the transceivers may then be sent to activate and/or modify the operation of one or some of the appliances.

It should be appreciated that the house 700 need not include a plurality of transceivers. A single transceiver may be sufficient to communicate with all the appliances in the house. Multiple central units may communicate with a single transceiver, each sending a specific signal based on the command each central unit received.

The control panel 735 or any other controller units (e.g., the users' cell phones) may be password or other-wise protected (e.g., by identifying biometric features of the user) so as to ensure the privacy of the user and smooth operation of the system and method.

In one example, demonstrating the methods and systems according to embodiments of the invention as part of a smart home or environment, a user may program his smart phone, using an appropriate application, by pressing a single button, to control an air conditioner to do the following: turn on at 25° C. on low fan, at 8 am, at 11 am to be set to 24° C. at medium fan until 7 pm after which the temperature is again set at 25° C. and the flaps of the air conditioner are moved to a different angle. At midnight the air conditioner is set to go off until the next morning at 8 am, etc. The operation of the air conditioner may be dependent on detecting movement of the presence of a human in the room such that the air conditioner is active only when a user is in the room. Several air conditioner (e.g., 711, 712 and 713) may be controlled the act simultaneously the same or multiple central units and/or multiple transceivers may be activated by a single button press to control different air conditioners to act differently according to specific rooms, floors, etc.

Similarly, a number of different houses can be controlled by a single controller unit. For example, a user may control appliances in his home and his office using a single device. A controller unit may also be used by a user to control appliances in his home and in hotel rooms, when the user is at a hotel. Other multi-location control scenarios are possible.

1. A system for remote control of appliances, the system comprising
a central unit to accept a command and to generate a control signal based on the command; and
a transceiver in wireless communication with the central unit and in wireless communication with an end device to receive the control signal from the central unit and to transmit to the end device an operating signal according to the control signal.

2. The system of claim 1 comprising a controller unit to accept an interaction from a user, to translate the interaction to a command and to transmit the command to the central unit.

3. The system of claim 2 wherein the controller unit comprises a sensor for accepting the interaction from the user.

4. The system of claim 3 wherein the sensor comprises an image sensor, an audio sensor, a motion detector, a human presence detector or any combination thereof.

5. The system of claim 4 wherein the controller unit comprises a processor and/or software to identify a gesture or posture of a user's hand or an audio signal and to translate the gesture, posture or audio signal to a command signal.

6. The system of claim 2 wherein the controller unit is configured to communicate with a server to accept from the server a remote control application and to transmit to the central unit a command signal associated with the remote control application.

7. The system of claim 6 wherein the controller unit, the central unit and/or the transceiver are configured to receive software updates from the server.

8. The system of claim 2 wherein the controller unit comprises universal control functions.

9. The system of claim 2 wherein the controller unit supports a GUI for remote control applications and for the universal control functions.

10. The system of claim 8 wherein the universal control functions comprise ON/OFF functions, temperature setting, amplitude of signal setting, timing of operation, TV or radio channel setting, appliance mode or any combination thereof.

11. The system of claim 2 wherein the controller unit device comprises a smartphone.

12. The system of claim 2 wherein the control unit is configured to emulate an existing remote control application.

13. The system of claim 1 comprising a plurality of transceivers and wherein the central unit is configured to generate a control signal which is transceiver specific.

14. The system of claim 1 comprising a plurality of central units wherein the command is a central unit specific signal.

15. The system of claim 1 wherein the central unit is configured to transmit the control signals according to a pre-planned schedule.

16. The system of claim 1 wherein the transceiver comprises at least one transmitter, the comprising an IR illumination source, an RF transmitter, a Bluetooth transmitter, an ultrasound transducer or a combination thereof.

17. The system of claim 16 wherein the transceiver comprises an array of transmitters, said array arranged to transmit in a wide angle.

18. The system of claim 17 wherein the controller unit is configured to specify an individual or group of transmitters from the array of transmitters, such that only the specified transmitter transmits to the end device an operating signal.

19. The system of claim 1 wherein the end device comprises a light fixture, air conditioner, oven, heater, electrical curtain, irrigation system, video and audio systems, an electrical switch or socket.

20. A transceiver for remote control of end devices, the transceiver comprising a receiver to receive a command and an array of transmitters, each transmitter configured to be individually controlled, to transmit an operating signal to an end device.

21. The transceiver of claim 20 wherein each transmitter has a unique electronic address.

22. The transceiver of claim 20 comprising an individual switch for each transmitter.

23. The transceiver of claim 20 wherein each transmitter is configured to be directed at a desired angle.

24. The transceiver of claim 20 wherein the transmitter comprises an IR illumination source, an RF transmitter, a Bluetooth transmitter, an ultrasound transducer or a combination thereof.

25. The transceiver of claim 20, said transceiver configured for communicating with a remote central unit or server.

26. The transceiver of claim 20, wherein the receiver is configured to communicate with a controller unit, said controller unit to transmit the command to the transceiver.

27. The transceiver of claim 20 comprising a receiver to receive signals from a remote control, said transceiver configured to record the signals from the remote control.

28. The transceiver of claim 20 comprising a receiver to receive signals from a remote control, said transceiver configured to send the signals received from the remote control to a central unit.

29. A method for remote control of appliances, the method comprising receiving a command from a control unit;
generating a control signal based on the received command;
transmitting the control signal to a remote wireless transceiver, the control signal to generate in the transceiver an operational signal to control an electrical appliance.

30. The method of claim 29 wherein the control signal is transceiver specific.

31. The method of claim 29 wherein the control signal is to generate in the transceiver a transmitter specific operational signal.
